(19) United States
(12) Patent Application Publication
(10) Pub. No.: US 2011/0141278 A1
(43) Pub. Date: Jun. 16, 2011

(54) Methods and Systems for Collaborative-Writing-Surface Image Sharing

(76) Inventors: Richard John Campbell, Camas, WA (US); Michael James HEILMANN, Vancouver, WA (US); John E. DOLAN, Vancouver, WA (US)

(21) Appl. No.: 12/697,076

(22) Filed: Jan. 29, 2010

Related U.S. Application Data
(63) Continuation of application No. 12/636,533, filed on Dec. 11, 2009.

(51) Int. Cl. H04N 7/18

(52) U.S. Cl. 348/143; 348/E07.085

(57) ABSTRACT

Aspects of the present invention are related to systems and methods for detection of content change on a collaborative writing surface and for image update and sharing based on the content-change detection.

### RELATED REFERENCES

This application is a continuation of U.S. patent application Ser. No. 12/636,533, entitled “Methods and Systems for Attaching Semantics to a Collaborative Writing Surface,” filed on Dec. 11, 2009, said application U.S. patent application Ser. No. 12/636,533 is hereby incorporated by reference herein, in its entirety.

### FIELD OF THE INVENTION

Embodiments of the present invention relate generally to collaboration systems and, in particular, to methods and systems for detection of content change on a collaborative writing surface and for image update and sharing based on the content-change detection.

### BACKGROUND

Flipcharts, whiteboards, chalkboards and other physical writing surfaces may be used to facilitate a creative interaction between peers. Methods and systems for capturing the information on these surfaces without hindering the creative interaction; allowing the captured information to be shared seamlessly and naturally between non-co-located parties; and generating a record of the interaction that may be subsequently accessed and replayed may be desirable.

### SUMMARY

Some embodiments of the present invention comprise methods and systems for detection of content change on a collaborative writing surface and for image update and sharing based on the content-change detection.

According to one aspect of the present invention, occlusion detection may be performed until an occlusion event associated with the collaborative writing surface may be detected. Then, dis-occlusion detection may be performed until a dis-occlusion event associated with the occlusion event is detected. After the detection of the occlusion/dis-occlusion event pair, a reference image, also referred to as a reference frame, associated with the collaborative writing surface may be updated. In some embodiments of the present invention, the reference image may be updated to an image, referred to as the current image or current frame, associated with the current view of the collaborative writing surface. In alternative embodiments of the present invention, a measure of the change between the current image and the reference image may be determined and if a significant change between the two images is measured, then the reference image may be updated.

According to a second aspect of the present invention, the reference frame may be shared, at each update, for viewing, archiving, journaling or other collaborative tasks. In some exemplary embodiments of the present invention, an updated reference frame may be sent from a host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

According to a third aspect of the present invention, an occlusion event may be declared based on changes between the current image and the reference image, in particular, changes of sufficient spatial contiguity and location proximate to a frame boundary.

According to yet another aspect of the present invention, an actor may be identified in association with each occlusion/dis-occlusion event pair. The identified actor may be indicated in the collaboration session record by an actor identification tag.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture depicting an exemplary collaboration system comprising a collaborative writing surface, an image acquisition system, a computing system and a communication link between the image acquisition system and the computing system;

FIG. 2 is a picture depicting an exemplary camera-view image of a exemplary collaborative writing surface and a rectified image showing an exemplary view of the collaborative writing surface after the removal of perspective distortion introduced by an off-axis placement of the camera relative to the collaborative writing surface;

FIG. 3 is a chart showing exemplary embodiments of the present invention comprising update of a reference frame associated with a collaborative writing surface after the detection of an occlusion/dis-occlusion event pair;

FIG. 4 is a picture of a finite state machine corresponding to exemplary embodiments of the present invention comprising update of a reference frame associated with a collaborative writing surface after the detection of an occlusion/dis-occlusion event pair;

FIG. 5 is a picture depicting an exemplary group of blocks associated with a difference image, and according to embodiments of the present invention: the white blocks represent blocks in which there was not a sufficient number of mask pixels exceeding the difference threshold to mark the block as a “changed” block; the four groupings of non-white pixels indicate “changed” blocks, of which the darkest blocks may not be considered an occluding object because this group of contiguous blocks is not connected to a frame boundary, the hatched blocks may be considered likely occluding objects, but may not trigger an occlusion event because their size is below a size threshold and the gray object may be considered an occluding object, based on its size and proximity to a frame boundary, and may trigger an occlusion event;

FIG. 6 is a chart showing exemplary embodiments of the present invention comprising occlusion detection and dis-occlusion detection;

FIG. 7 is a chart showing exemplary embodiments of the present invention comprising actor identification;

FIG. 8 is a picture of a finite state machine corresponding to exemplary embodiments of the present invention comprising actor identification;

FIG. 9 is a chart showing exemplary embodiments of the present invention comprising updating a reference image based on the detection of an occlusion/dis-occlusion event pair;

FIG. 10 is a chart showing exemplary embodiments of the present invention comprising updating a reference image based on the detection of an occlusion/dis-occlusion event pair and maintaining a collaboration script;

FIG. 11 is a chart showing exemplary embodiments of the present invention comprising updating a reference image and an actor identification tag based on the detection of an occlusion/dis-occlusion event pair; and

FIG. 12 is a chart showing exemplary embodiments of the present invention comprising updating a reference image and an actor identification tag based on the detection of an occlusion/dis-occlusion event pair and maintaining a collaboration script.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention, but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Flipcharts, whiteboards, chalkboards and other physical writing surfaces may be used to facilitate a creative interaction between peers. Methods and systems for capturing the information on these surfaces without hindering the creative interaction; allowing the captured information to be shared seamlessly and naturally between non-co-located parties; and generating a record of the interaction that may be subsequently accessed and replayed may be desirable.

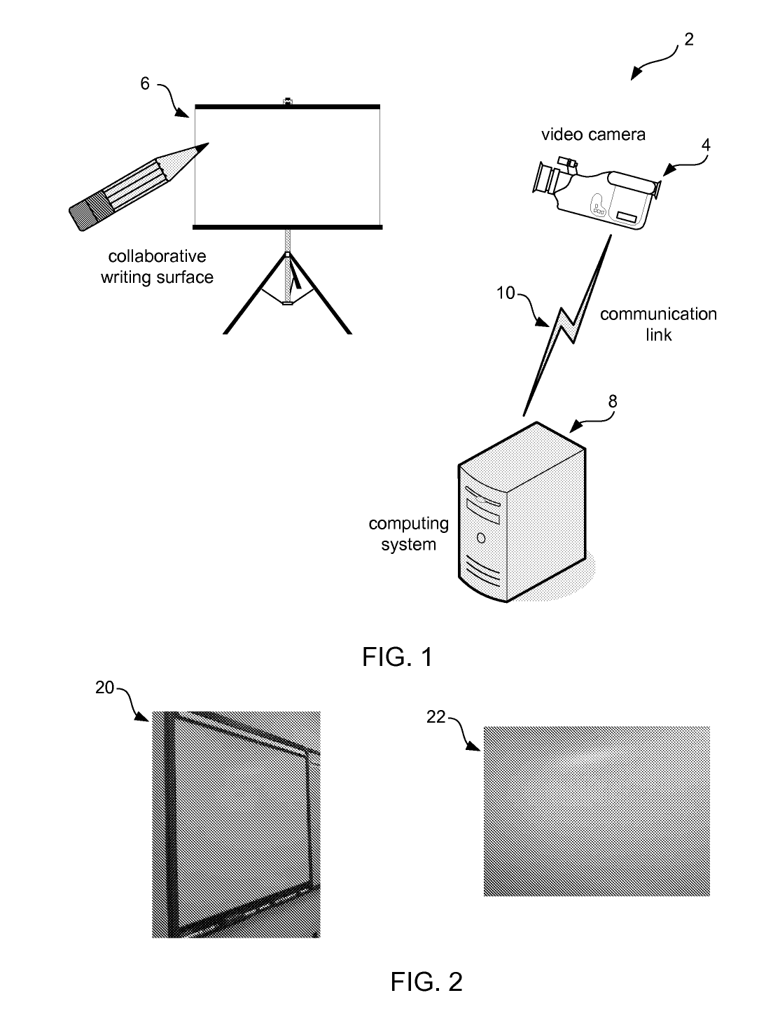

The present invention comprises methods for forming an image of a collaborative writing surface, and in some of the exemplary embodiments described herein, the method may be implemented in a computing device. Embodiments of the present invention comprise methods and systems for capturing, sharing and recording the information on a collaborative writing surface. Exemplary collaborative writing surfaces may include a flipchart, a whiteboard, a chalkboard, a piece of paper and other physical writing surfaces. Some embodiments of the present invention may comprise a collaboration system 2 that may be described in relation to FIG. 1. The collaboration system 2 may comprise a video camera, or other image acquisition system, 4 that is trained on a collaborative writing surface 6. In some embodiments of the present invention, color image data may be acquired by the video camera 4. In alternative embodiments, the video camera 4 may acquire black-and-white image data. The video camera 4 may be communicatively coupled to a host computing system 8. Exemplary host computing systems 8 may comprise a single computing device or a plurality of computing devices. In some embodiments of the present invention, wherein the host computing system 8 comprises a plurality of computing devices, the computing devices may be co-located. In alternative embodiments of the present invention, wherein the host computing system 8 comprises a plurality of computing devices, the computing devices may not be co-located.

The connection 10 between the video camera 4 and the host computing system 8 may be any wired or wireless communications link.

In some embodiments of the present invention, the video camera 4 may be placed at an off-axis viewpoint that is non-perpendicular to the collaborative writing surface 6 to provide a minimally obstructed view of the collaborative writing surface 6 to local collaboration participants.

The video camera 4 may obtain image data associated with the collaborative writing surface 6. In some embodiments, the image data may be processed, in part, by a processor on the video camera 4 and, in part, by the host computing system 8. In alternative embodiments, the image data may be processed, in whole, by the host computing system 8.

In some embodiments of the present invention, raw sensor data obtained by the video camera 4 may be demosaiced and rendered. Demosaicing may reconstruct coincident three-color output data from non-coincident samples obtained by a camera filter array. Exemplary embodiments of the present invention may comprise a Bayer filter array in the video camera 4 and may comprise methods and systems known in the art for demosaicing color data obtained from a Bayer filter array. Alternative demosaicing methods and systems known in the art may be used when the digital camera 4 sensor array is a non-Bayer filter array.

In some embodiments of the present invention, the collaboration system 2 may comprise an image rectifier to eliminate, in the rendered image data, perspective distortion introduced by the relative position of the video camera 4 and the collaborative writing surface 6. FIG. 2 depicts an exemplary camera-view image 20 and the associated image 22 after geometric transformation to eliminate perspective distortion.

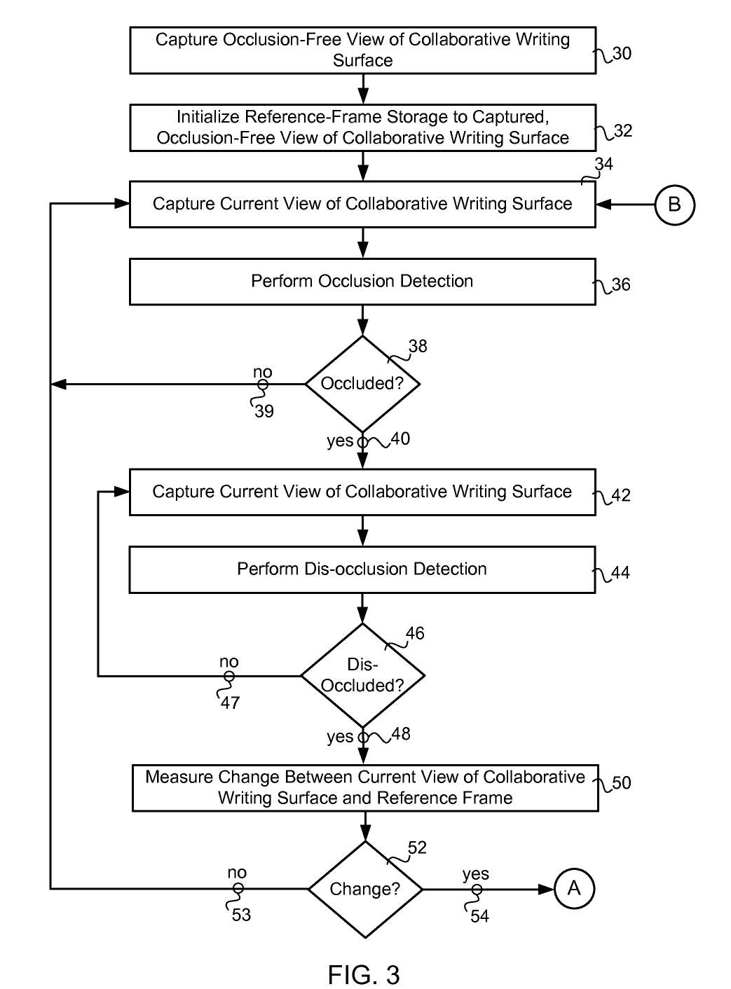

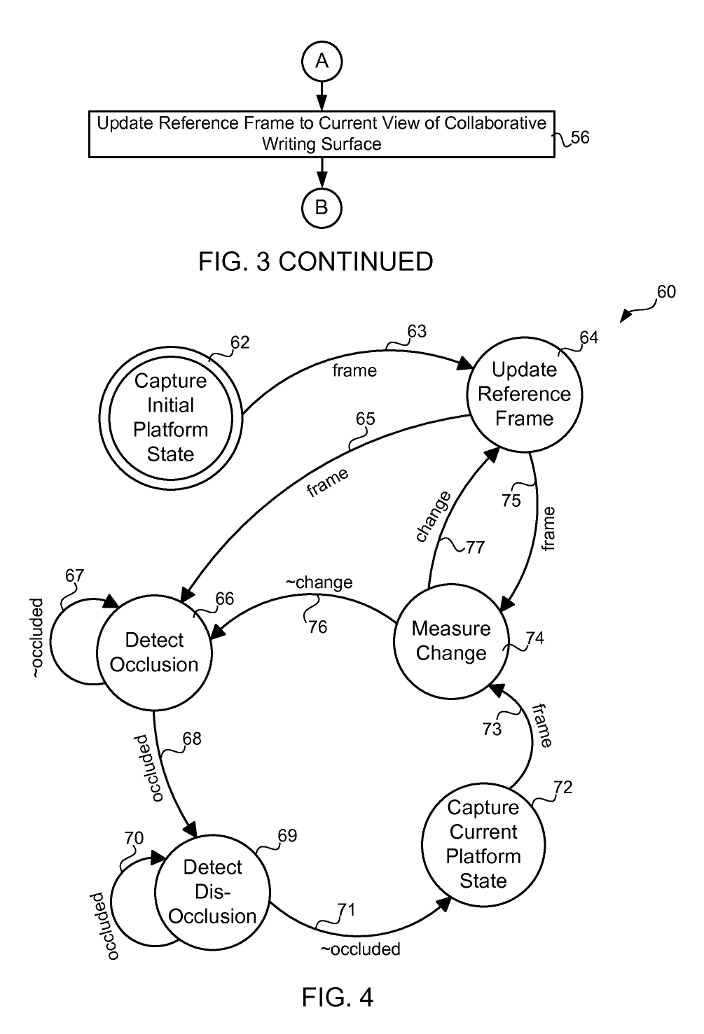

Some embodiments of the present invention may be described in relation to FIG. 3. In these embodiments, an occlusion-free view of a collaborative writing surface may be captured 30. A memory, buffer or other storage associated with a reference frame, also considered a reference image, may be initialized 32 to the captured, occlusion-free view of the collaborative writing surface. A current view of the collaborative writing surface may be captured 34, and occlusion detection may be performed 36. The captured current view of the collaborative writing surface may be referred to as the current frame, or current image. If no occluding event is detected 39, then the current-view capture 34 and occlusion detection 36 may continue. If an occluding event is detected 40, a current view of the collaborative writing surface may be captured 42 and dis-occlusion detection 44 may be performed. While the current view remains occluded 47, the current-view capture 42 and dis-occlusion detection 44 may continue. When the current view is determined 46 to be dis-occluded 48, then the change between the current frame and the reference frame may be measured 50. If there is no measured change 53, then the current-view capture 34 and occlusion detection 36 continue. If there is a measured change 54, then the reference frame may be updated 56 to the current frame by writing the current frame data to the memory, buffer or other storage associated with the reference frame. The current-view capture 34 and occlusion detection 36 may then continue.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

Some embodiments of the present invention may be understood in relation to a finite state machine (FSM) diagram 60 shown in FIG. 4. Some embodiments of the present invention may comprise the finite state machine 60 embodied in hardware. Alternative embodiments of the present invention may comprise the finite state machine 60 embodied in a computer-program product that is a computer-readable storage medium, and/or media, having instructions stored thereon, and/or therein, that may be used to program a computer to perform the features of the finite state machine 60. Still alternative embodiments may comprise the finite state machine 60 embodied in a combination of hardware and a computer-program product that is a computer-readable storage medium, and/or media, having instructions stored thereon, and/or therein, that may be used to program a computer to perform the features of the finite state machine 60.

An initial platform state may be captured 62, and the capture may trigger a transition 63 to an “update-reference-frame” state 64, in which an image frame associated with the initial capture may be used to initialize a reference frame, also referred to as a reference image, associated with the collaboration system. In some embodiments of the present invention, the initial platform state may be associated with an unobstructed view of the collaborative writing surface. The updating of the reference frame may trigger 65, 75 a state transition to a “detect-occlusion” state 66, in which it may be determined whether or not the view of the collaborative writing surface is obstructed, and a “measure-change” state 74, in which the change between an image associated with the current platform state and the reference image may be measured. If there is no occlusion detected, the collaboration system may remain 67 in the “detect-occlusion” state 66. If there is occlusion detected, the system may transition 68 to a “detect-dis-occlusion” state 69, in which it may be determined whether or not the view of collaborative writing surface is unobstructed. If there is no dis-occlusion detected, the system may remain 70 in the “detect-dis-occlusion” state 69. If there is dis-occlusion detected, the system may transition 71 to a “capture-current-platform” state 72, in which the current state of the platform may be captured. The capture of the dis-occluded frame may trigger a transition 73 to the “measure-change” state 74. If there is no measured change between the current frame and the reference frame, the system may transition 76 to the “detect-occlusion” state 66. If there is measurable change, then the system may transition 77 to the “update-reference-frame” state 64, in which the reference image may be updated to the captured dis-occluded frame. Updating the reference frame may trigger the transition 75 to the “measure-change” state 74.

In some embodiments of the present invention, occlusion detection may comprise comparing a current frame to a reference frame that is known to be occlusion free. The reference frame may be initialized when the collaborative-writing system is first initiated and subsequently updated, after an occlusion/dis-occlusion event pair.

In an exemplary embodiment, the difference between the luminance component of the reference frame, also referred to as the key frame, and the luminance component of the current frame may be determined according to:

f_{diff}=L_{key}−L_{curr},

where f_{diff}, L_{key} and L_{curr} may denote the luminance difference, the luminance component of the reference frame and the luminance component of the current frame, respectively. In some embodiments, a luminance component may be computed for an RGB (Red-Green-Blue) image according to:

L_{(·)}=0.375R_{(·)}+0.5G_{(·)}+0.125B_{(·)},

where L_{(·)}, (R_{(·)}, (G_{(·)} and B_{(·)} may denoted the luminance, red, green and blue components of a frame, respectively. In alternative embodiments, a luminance component may be computed for an RGB image according:

L_{(·)}=0.3R_{(·)}+0.6G_{(·)}+0.1B_{(·)}. For a collaborative writing surface with a light background color, for example, a whiteboard or a flipchart, an occluding object may appear darker than the writing surface. If a collaborative writing surface has a darker background color, then an occluding object may appear lighter than the writing surface. The background color of the collaborative writing surface may be determined at system initialization. The following exemplary embodiments will be described for a collaborative writing surface with a light-colored background. This is for illustrative purposes and is not a limitation.

In exemplary embodiments comprising a collaborative writing surface with a light-colored background, negative-valued f_{diff} pixels may correspond to locations where the current frame appears brighter than the reference frame, and these pixels may be ignored in occlusion detection. Additionally, the difference signal, f_{diff}, may contain spurious content due to noise in the imaging system, variations in the lighting conditions and other factors. The magnitude of the difference signal, f_{diff}, at a pixel location may denote the significance of a change at that position. Hence, small positive values in f_{diff} may also be eliminated for further processing in the occlusion-detection stage. In some embodiments, the pixel values of f_{diff} may be compared to a difference threshold, which may be denoted T_{occ}, to determine which pixel locations may be associated with likely occlusion. A binary mask of the locations may be formed according to:

$${m}_{diff} ( i , j ) = \{ \begin{matrix}1 , & {f}_{diff} ( i , j ) > {T}_{occ} \\ 0 , & otherwise ,\end{matrix}$$

where m_{diff} may denote the mask and (i, j) may denote a pixel location.

The mask m_{diff} may be divided into non-overlapping blocks, and the number of pixels in each block that exceed the difference threshold, T_{occ}, may be counted. If the count for a block exceeds a block-density threshold, which may be denoted T_{bden}, then the block maybe marked as a “changed” block. Contiguous “changed” blocks that are connected to a frame boundary may be collectively labeled as an occluding object. “Changed” blocks that do not abut a frame boundary may represent noise or content change, and these “changed” blocks may be ignored. An occlusion event may be declared if the size of an occluding object exceeds a size threshold, which may be denoted T_{objsize}.

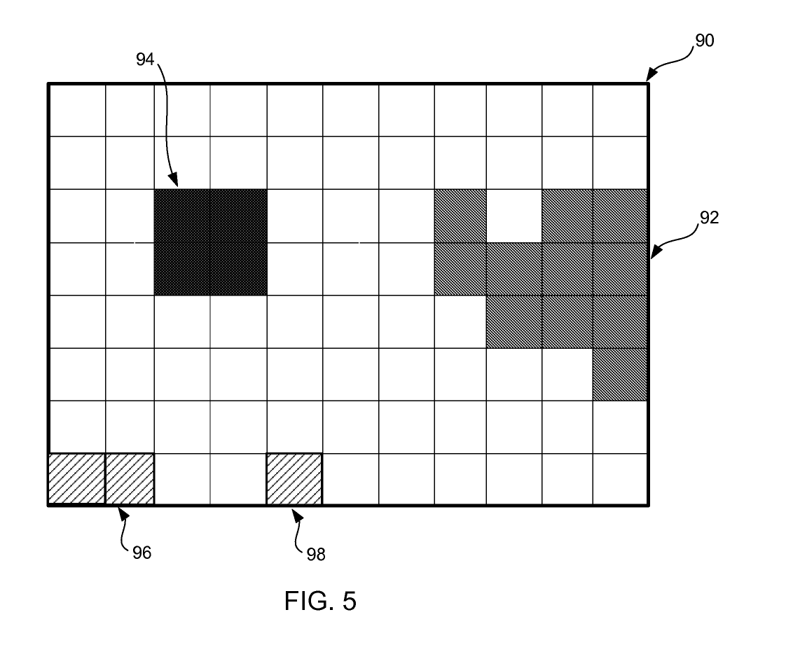

FIG. 5 depicts an exemplary group of blocks 90 associated with a difference image. The white blocks represent blocks in which there was not a sufficient number of mask pixels exceeding the difference threshold to mark the block as a “changed” block. The four groupings 92, 94, 96, 98 of non-white pixels indicate “changed” blocks. The darkest blocks 94 may not be considered an occluding object because this group of contiguous blocks is not connected to a frame boundary. The hatched blocks 96, 98 may be considered likely occluding objects, but may not trigger an occlusion event because their size is below a size threshold. The gray object 92 may be considered an occluding object, based on its size and proximity to a frame boundary, and may trigger an occlusion event.

In an exemplary embodiment of the present invention, the size of a block may be 80 pixels by 80 pixels.

In an exemplary embodiment of the present invention comprising 8-bit luminance values, the difference threshold, T_{occ}, may be 15.

In an exemplary embodiment of the present invention, the block-density threshold, T_{bden}, may be 50 percent of the number of pixels in the block. In these embodiments, a block may be labeled as a “changed” block if at least 50 percent of the pixels in the block exceed the difference threshold, T_{occ}.

In an exemplary embodiment of the present invention, an occlusion event may be triggered if an occluding object consists of at least 30 blocks.

An occlusion event may be marked and maintained as long as subsequent frames contain an occluding object of sufficient size, located abutting a frame boundary. These subsequent frames may not be stored or analyzed for content change. Once a subsequent frame is received for which there is no occlusion event detected, the frame may be analyzed to detect new content.

In some embodiments of the present invention, dis-occlusion detection may comprise the same process as occlusion detection, with a dis-occlusion event triggered when there are no occluding objects detected or when there are no occluding objects of sufficient size to trigger an occlusion event.

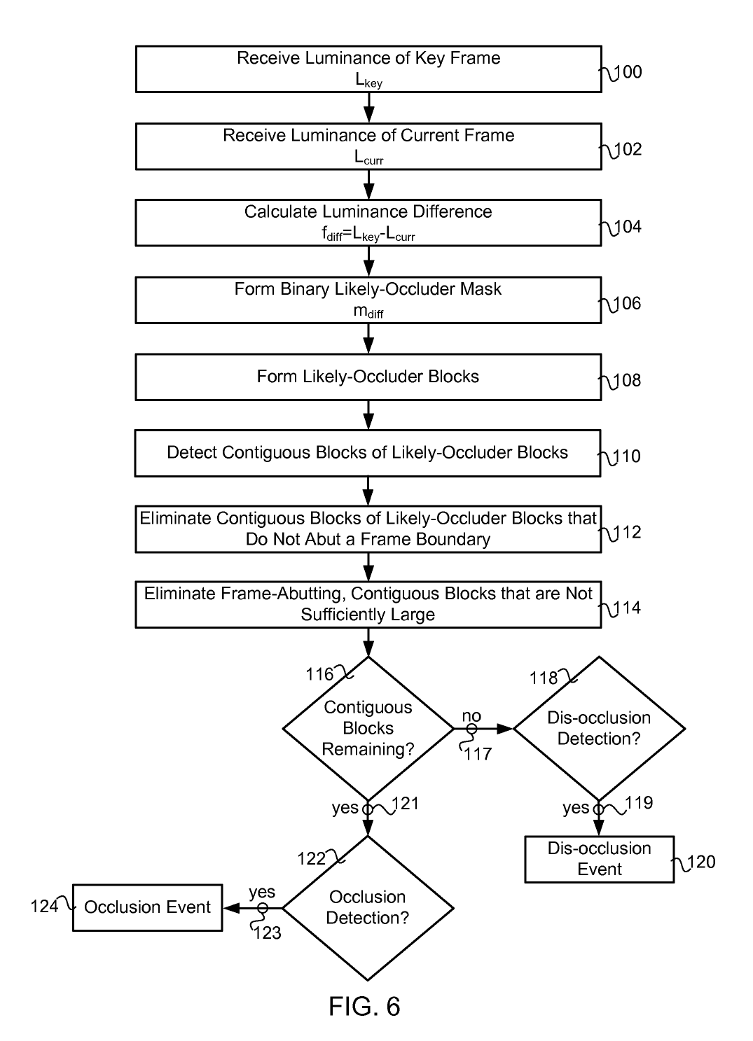

An exemplary embodiment of occlusion detection and dis-occlusion detection according to embodiments of the present invention may be understood in relation to FIG. 6. In these exemplary embodiments, a luminance image, L_{key}, associated with a key frame may be received 100. A luminance image, L_{curr}, associated with a current frame may be received 102. A luminance difference image, f_{diff}, may be calculated 104 according to:

f_{diff}=L_{key}−L_{curr}.

A binary likely-occluder mask, m_{diff}, may be formed 106 according to:

$${m}_{diff} ( i , j ) = \{ \begin{matrix}1 , & {f}_{diff} ( i , j ) > {T}_{occ} \\ 0 , & otherwise ,\end{matrix}$$

and likely-occluder blocks, also referred to as changed blocks, may be formed 108 from the binary likely-occluder mask.

The likely-occluder blocks may be formed 108 by dividing the binary likely-occluder mask, m_{diff}, into non-overlapping blocks, and the number of pixels in each block that exceed a difference threshold, T_{occ}, may be counted. If the count for a block exceeds a block-density threshold, which may be denoted T_{bden}, then the block maybe marked as a “changed” block, also referred to as a likely-occluder block. Contiguous “changed” blocks may be detected 110. Contiguous “changed” blocks that do not abut a frame boundary may be eliminated 112 as likely-occluder blocks. The size of remaining contiguous “changed” blocks may be used to eliminate 114 frame-abutting, contiguous blocks that are not sufficiently large enough to be associated with an occluding object.

If there are no contiguous “changed” blocks remaining 117 after elimination based on location 112 and size 114, then if dis-occlusion detection is being performed 119, a dis-occulusion event may be declared 120. If there are contiguous “changed” blocks remaining 121 after elimination based on location 112 and size 114, then if occlusion detection is being performed 123, an occlusion event may be declared 124. Otherwise, the current dis-occlusion/occlusion state may be maintained.

In some embodiments of the present invention, edge information in the current image frame and the reference image frame may be computed to determine changes, also considered updates, to the collaborative writing surface. The gradient of the current image may be calculated, and the current gradient image may be divided into non-overlapping blocks. For each block, the number of edge pixels for which the gradient magnitude exceeds a threshold, which may be denoted T_{g}, may be calculated. An edge count associated with a block in the current gradient image may be compared to the edge count associated with the corresponding block in a reference gradient image that represents the state of the collaborative writing surface prior to the occlusion event. If the number of edge pixels in one or more blocks has sufficiently changed, it may be concluded that the current frame includes significant content changes, and the current frame may be stored as part of the collaboration session. In some embodiments, to determine if a sufficient number of edge pixels in a block has changed, the ratio of the number edge pixels changed in the block of the current gradient image relative to the corresponding block in the reference gradient image may be compared to a threshold, which may be denoted T_{b}. The block may contain significant content change if the ratio meets a first criterion, for example, is greater than or is greater than or equal to, in relation to the threshold value. The reference block edge information may be updated using the current block edge information.

The values of the gradient threshold, T_{g}, and the block edge change detection threshold, T_{b}, may be selected in various ways. In one embodiment of the invention, T_{g} and T_{b} may be set empirically to 800 and 0.25, respectively.

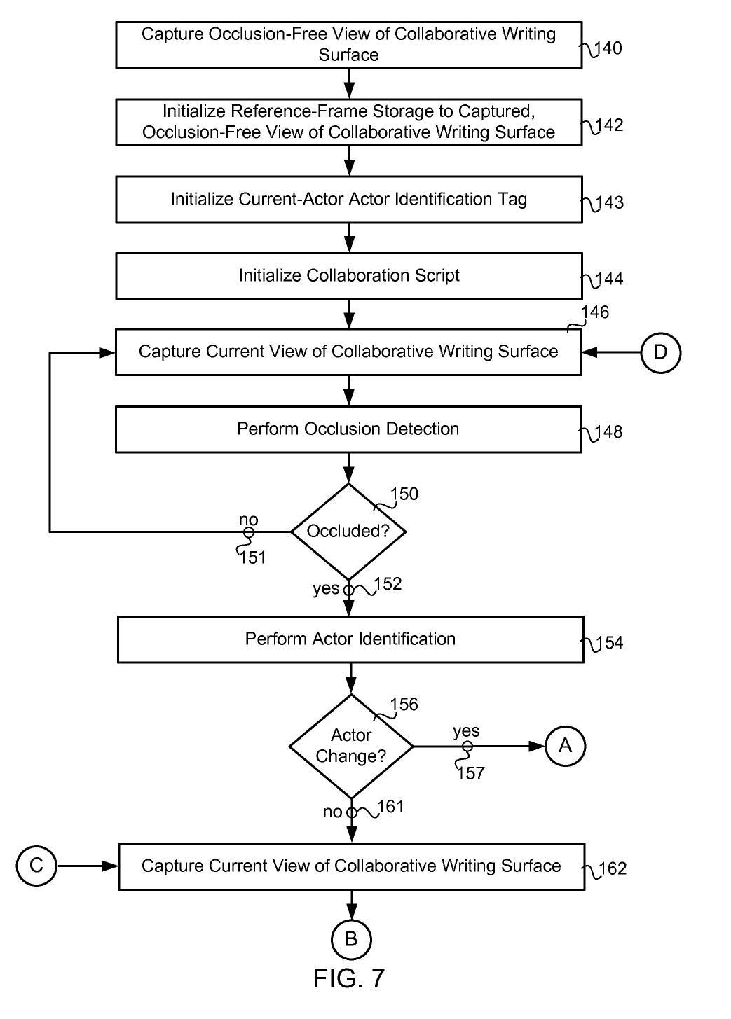

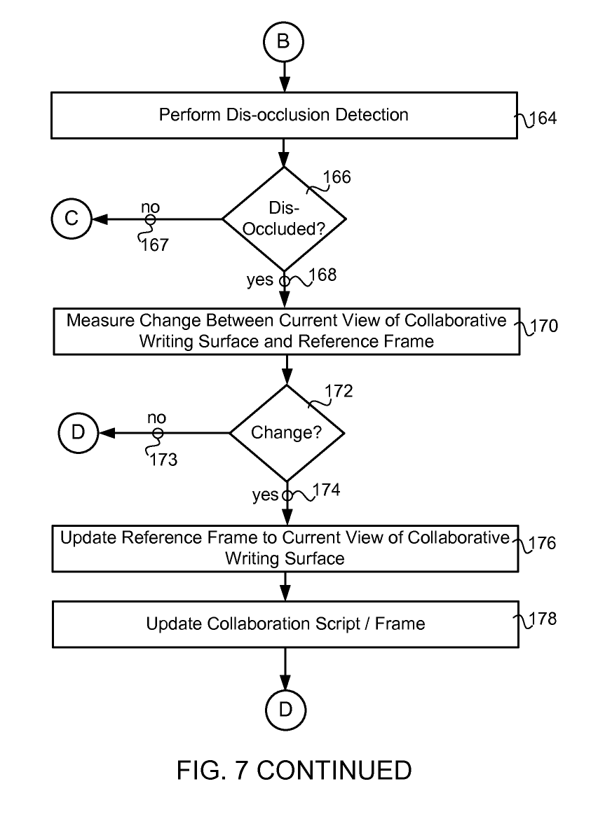

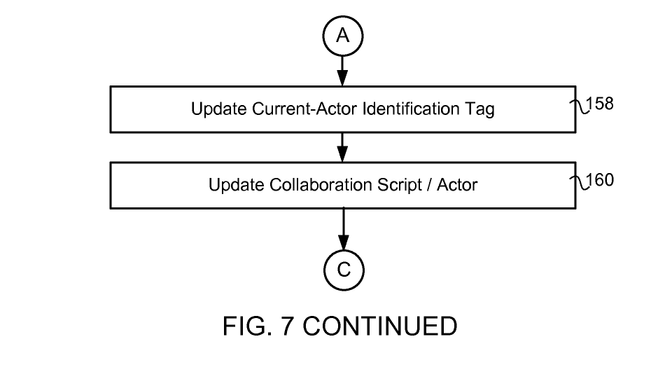

In some embodiments of the present invention described in relation to FIG. 7, an actor may be associated with each occlusion/dis-occlusion event. The actor associated with the occlusion/dis-occlusion event may be identified by an actor identification tag. In some embodiments of the present invention, the actor identification tag may be the person's name or other unique alphanumeric identifier associated with the person. In alternative embodiments, the actor identification tag associated with a person may be a picture, or image, of the person. In some of these embodiments, the picture may be a real-time-captured picture captured during the collaborative session. In alternative embodiments, the picture may be a previously captured picture stored in a database, or other memory, associated with the collaboration system.

In these actor-identified embodiments, an occlusion-free view of a collaborative writing surface may be captured 140. A memory, buffer or other storage associated with a reference frame, also considered a reference image, may be initialized 142 to the captured, occlusion-free view of the collaborative writing surface, and a current-actor actor identification tag may be initialized 143 to an initial tag value. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session. A collaboration script associated with the collaboration session may be initialized 144. In some embodiments of the present invention, the collaboration script may initially comprise the occlusion-free view of the collaborative writing surface and the initial current-actor actor identification tag. In alternative embodiments of the present invention, the collaboration script may be initialized to a “null” indicator.

A current view of the collaborative writing surface may be captured 146, and occlusion detection may be performed 148. The captured current view of the collaborative writing surface may be referred to as the current frame, or current image. If no occluding event is detected 151, then the current-view capture 146 and occlusion detection 148 may continue. If an occluding event is detected 152, actor identification may be performed 154. In some embodiments of the present invention, actor identification 154 may comprise facial recognition. In alternative embodiments of the present invention, actor identification 154 may comprise voice recognition. In still alternative embodiments of the present invention, actor identification 154 may comprise querying collaboration participants for the actor identification tag.

If an actor change is detected 157 relative to the current-actor actor identification tag, then the current-actor actor identification tag may be updated 158 and a collaboration script associated with the current collaboration session may be updated 160 to reflect the change in actor. The current view of the collaborative writing surface may then be captured 162, as it would be if no change in actor is detected 161.

After the current view of the collaborative writing surface is captured 162, dis-occlusion detection 164 may be performed. While the current view remains occluded 167, the current-view capture 162 and dis-occlusion detection 164 may continue. When the current view is determined 166 to be dis-occluded 168, then the change between the current frame and the reference frame may be measured 170. If there is no measured change 173, then the current-view capture 146 and occlusion detection 148 continue. If there is a measured change 174, then the reference frame may be updated 176 to the current frame by writing the current frame data to the memory, buffer or other storage associated with the reference frame, and the collaboration script may be updated 178 to reflect the new view of the collaborative writing surface. The current-view capture 146 and occlusion detection 148 may then continue.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

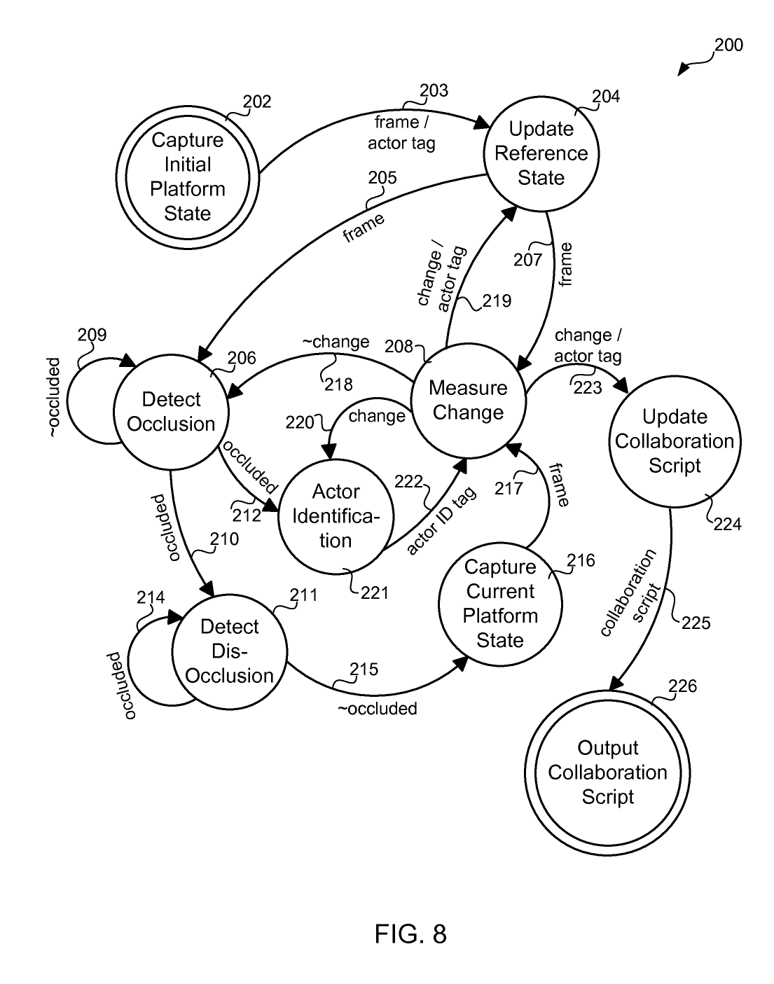

Some embodiments of the present invention may be understood in relation to a finite state machine (FSM) diagram 200 shown in FIG. 8. Some embodiments of the present invention may comprise the finite state machine 200 embodied in hardware. Alternative embodiments of the present invention may comprise the finite state machine 200 embodied in a computer-program product that is a computer-readable storage medium, and/or media, having instructions stored thereon, and/or therein, that may be used to program a computer to perform the features of the finite state machine 200. Still alternative embodiments may comprise the finite state machine 200 embodied in a combination of hardware and a computer-program product that is a computer-readable storage medium, and/or media, having instructions stored thereon, and/or therein, that may be used to program a computer to perform the features of the finite state machine 200.

An initial platform state may be captured 202, and the capture may trigger a transition 203 to an “update-reference-state” state 204 in which the image frame associated with the initial capture may be used to initialize a reference frame, also referred to as a reference image, associated with the collaboration system and an initial actor identification tag may be used to initialize a current-actor identification tag. In some embodiments of the present invention, the initial platform state may be associated with an unobstructed view of the collaborative writing surface. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session.

The updating of the reference image may trigger a state transition 205 to a “detect-occlusion” state 206, in which it may be determined whether or not the view of the collaborative writing surface is obstructed, and a state transition 207 to a “measure-change” state 208, in which the change between an image associated with the current platform state and the reference image may be measured and in which the change between a currently identified actor and a reference actor may be measured. From the “detect-occlusion” state 206, if there is no occlusion detected, the system may remain 209 in the “detect-occlusion” state 206. If there is occlusion detected, the system may transition 210 to a “detect-dis-occlusion” state 211, in which it may be determined whether or not the view of the collaborative writing surface is unobstructed. From the “detect-dis-occlusion” state 211, if there is no dis-occlusion detected, the system may remain 214 in the “detect-dis-occlusion” state 211. If there is dis-occlusion detected, the system may transition 215 to a “capture-current-platform” state 216, in which the current state of the platform may be captured. The capture of the dis-occluded frame may trigger a transition 217 to the “measure-change” state 208. If there is no measured change between the current frame and the reference frame, the system may transition 218 to the “detect-occlusion” state 206. If there is measurable change, then the system may transition 219 to the “update-reference-frame” state 204. Measureable change may also cause a transition 220 from the “measure-change” state 208 to an “actor-identification” state 221, in which the actor currently in view may be identified. Additionally, a detection of occlusion in the “detect-occlusion” state 206 may cause a transition 212 from the “detect-occlusion” state 206 to the “actor-identification” state 221. Determination of an actor ID tag may cause a transition 22 to the “measure-change” state 208. Detection of change in the un-occluded image or the actor identification tag may trigger a transition 223 to an “update-collaboration-script” state 224, in which a collaboration script associated with the collaboration session may be updated. Updating the collaboration script may trigger a state transition 225 to an “output-collaboration-script” state 226, in which the updated collaboration script may be made available to collaboration partners, a collaboration archive, a collaboration journal or other collaboration repository.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

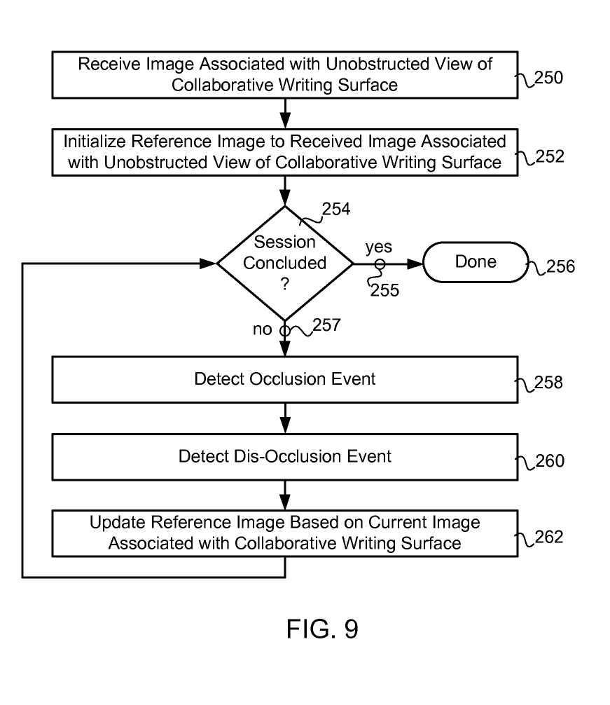

Some embodiments of the present invention described in relation to FIG. 9 may relate to capturing and sharing information from a collaborative writing surface during a collaboration session and may comprise receiving 250 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 252 to the received image associated with the unobstructed view of the collaborative writing surface. If the collaboration session has concluded 255, then the capturing and sharing of the information from the collaborative writing surface may be terminated 256. If the collaboration session has not concluded 257, then occlusion detection may be performed until an occlusion event is detected 258. In some embodiments of the present invention, occlusion detection may be performed according to any of the above-described methods and systems of the present invention. After an occlusion event is detected, dis-occlusion detection may be performed until a dis-occlusion event is detected 260, and the reference image may be updated 262 based on a currently captured image of the collaborative writing surface. In some embodiments of the present invention, dis-occlusion detection may be performed according to any of the above-described methods and systems of the present invention. In some embodiments of the present invention, the reference image may be updated 262 to the current image associated with the collaborative writing surface. In alternative embodiments of the present invention, the reference image may be updated 262 based on changes between the current image associated with the collaborative writing surface and reference image. After the reference image has been updated 262, then the session-concluded determination 254 may be made.

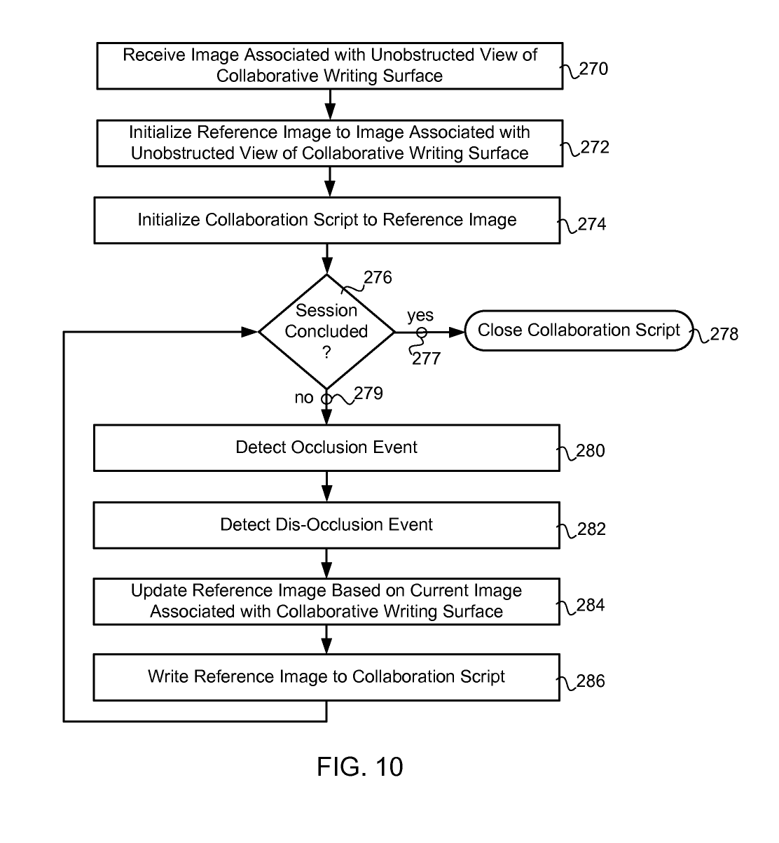

Some embodiments of the present invention described in relation to FIG. 10 may relate to capturing and sharing information from a collaborative writing surface during a collaboration session and may comprise receiving 270 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 272 to the received image associated with the unobstructed view of the collaborative writing surface, and a collaboration script may be initialized 274 to comprise the reference image. If the collaboration session has concluded 277, then the capturing and sharing of the information from the collaborative writing surface may be terminated by closing the collaboration script 278. If the collaboration session has not concluded 279, then occlusion detection may be performed until an occlusion event is detected 280. In some embodiments of the present invention, detection of an occlusion event may be performed according to any of the above-described methods and systems of the present invention. After an occlusion event is detected, dis-occlusion detection may be performed until a dis-occlusion event is detected 282, and the reference image may be updated 284 based on a currently captured image of the collaborative writing surface. In some embodiments of the present invention, dis-occlusion detection may be performed according to any of the above-described methods and systems of the present invention. In some embodiments of the present invention, the reference image may be updated 284 to the current image associated with the collaborative writing surface. In alternative embodiments of the present invention, the reference image may be updated 284 based on changes between the current image associated with the collaborative writing surface and reference image. The updated reference image may be written to the collaboration script 286, and the check may be made 276 to determine if the collaboration session has concluded.

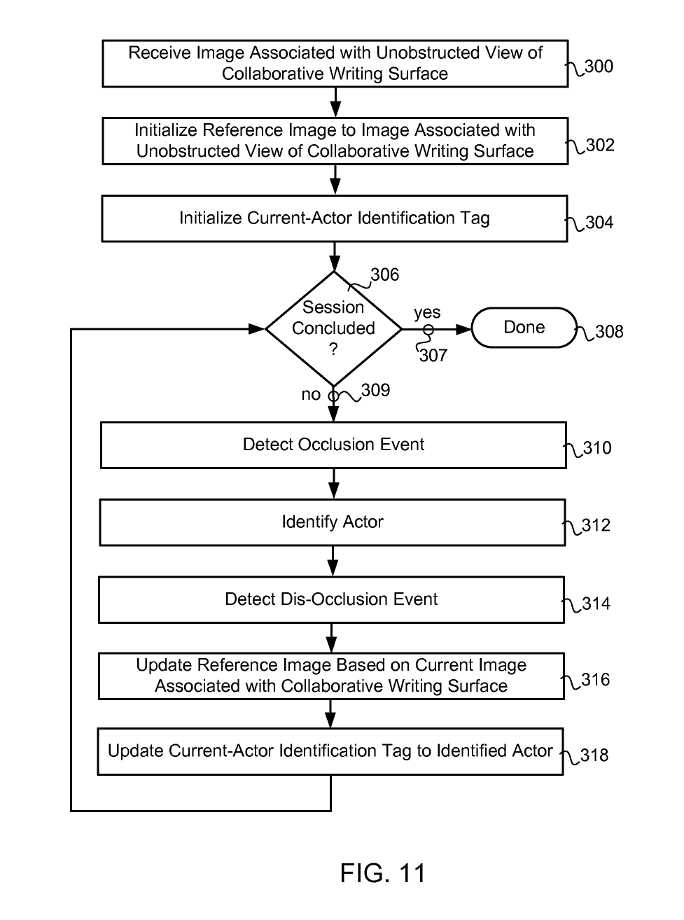

Some embodiments of the present invention described in relation to FIG. 11 may relate to capturing and sharing information from a collaborative writing surface during a collaboration session and may comprise receiving 300 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 302 to the received image associated with the unobstructed view of the collaborative writing surface, and a current-actor identification tag may be initialized 304. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session.

If the collaboration session has concluded 307, then the capturing and sharing of the information from the collaborative writing surface may be terminated 308. If the collaboration session has not concluded 309, then occlusion detection may be performed until an occlusion event may be detected 310. In some embodiments of the present invention, detection of an occlusion event may be performed according to any of the above-described methods and systems of the present invention. An actor associated with the occlusion event may be identified 312, and dis-occlusion detection may be performed until a dis-occlusion event may be detected 314. The reference image may be updated 316 based on a currently captured image of the collaborative writing surface. In some embodiments of the present invention, dis-occlusion detection may be performed according to any of the above-described methods and systems of the present invention. In some embodiments of the present invention, the reference image may be updated 316 to the current image associated with the collaborative writing surface. In alternative embodiments of the present invention, the reference image may be updated 316 based on changes between the current image associated with the collaborative writing surface and reference image. The current-actor identification tag may be updated 318 to the identified actor. After the reference image and the current-actor identification tag have been updated 316, 318, then the session-concluded determination 306 may be made.

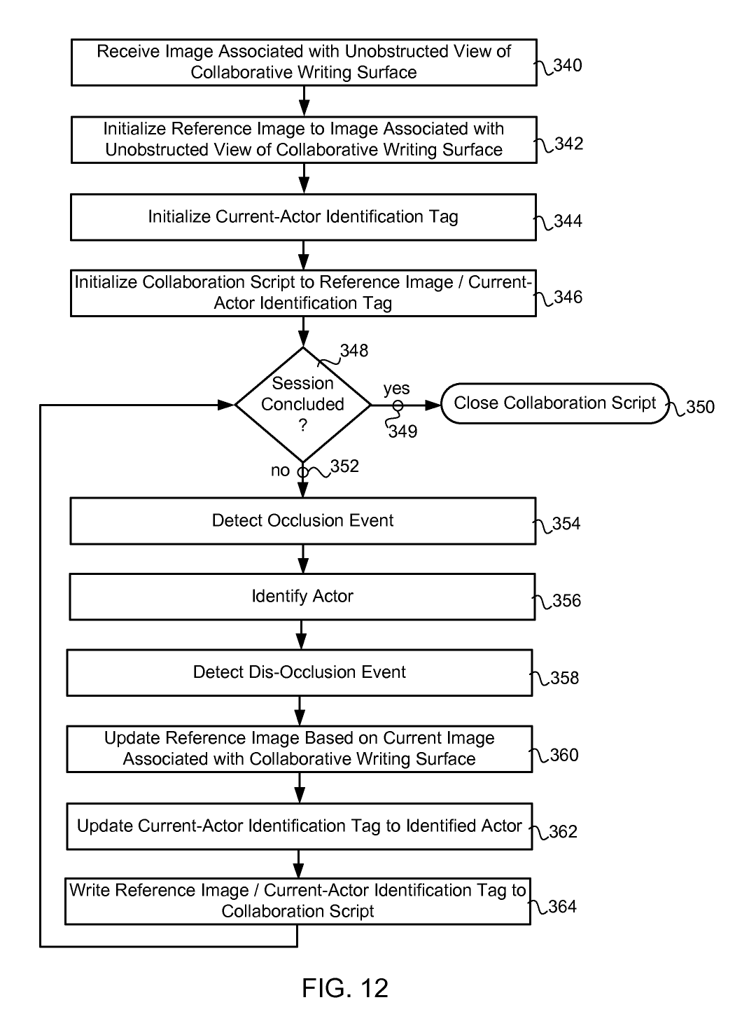

Some embodiments of the present invention described in relation to FIG. 12 may relate to capturing and sharing information from a collaborative writing surface during a collaboration session and may comprise receiving 340 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 342 to the received image associated with the unobstructed view of the collaborative writing surface, and a current-actor identification tag may be initialized 344. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session. A collaboration script may be initialized 346 to comprise the reference image and current-actor identification tag.

If the collaboration session has concluded 349, then the capturing and sharing of the information from the collaborative writing surface may be terminated 350 by closing the collaboration script. If the collaboration session has not concluded 352, then occlusion detection may be performed until an occlusion event may be detected 354. In some embodiments of the present invention, detection of an occlusion event may be performed according to any of the above-described methods and systems of the present invention. An actor associated with the occlusion event may be identified 356, and dis-occlusion detection may be performed until a dis-occulsion event may be detected 358. The reference image may be updated 360 based on a currently captured image of the collaborative writing surface. In some embodiments of the present invention, dis-occlusion detection may be performed according to any of the above-described methods and systems of the present invention. In some embodiments of the present invention, the reference image may be updated 360 to the current image associated with the collaborative writing surface. In alternative embodiments of the present invention, the reference image may be updated 360 based on changes between the current image associated with the collaborative writing surface and reference image. The current-actor identification tag may be updated 362 to the identified actor. After the reference image and the current-actor identification tag have been updated 360, 362, then the updated reference image and current-actor identification tag may be written to the collaboration script. The session-concluded determination 348 may be made.

Although the charts and diagrams in the figures described herein may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that software, hardware and/or firmware may be created by one of ordinary skill in the art to carry out the various logical functions described herein.

Some embodiments of the present invention may comprise a computer-program product that is a computer-readable storage medium, and/or media, having instructions stored thereon, and/or therein, that may be used to program a computer to perform any of the features presented herein.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A computer-implemented method for forming an image of a collaborative writing surface, said method comprising:
a) detecting an occlusion event associated with a collaborative writing surface;
b) detecting a dis-occlusion event associated with said detected occlusion event;
c) capturing an image of said collaborative writing surface corresponding to said dis-occlusion event; and
d) forming an image based on said captured image of said collaborative writing surface.

2. The method as described in claim 1, wherein said forming comprises eliminating perspective distortion in said captured image.

3. The method as described in claim 1, wherein said forming comprises demosaicing said captured image.

4. The method as described in claim 1, wherein said forming comprises determining changes between a reference image of said collaborative writing surface and said captured image.

5. The method as described in claim 4, wherein said determining changes comprises:
a) determining the edge content in a said reference image;
b) determining the edge content in said captured image; and
c) comparing said reference-image edge content to said captured-image edge content.

6. The method as described in claim 1, wherein said detecting an occlusion event comprises:
a) receiving a current luminance image associated with said collaborative writing surface;
b) receiving a reference luminance image associated with said collaborative writing surface;
c) identifying a plurality of contiguous likely-occluder-blocks in an image formed using said current luminance image and said reference luminance image; and
d) declaring an occlusion event when at least one contiguous likely-occluder-block in said plurality of likely-occluder-blocks meets a size condition and a location condition.

7. The method as described in claim 6, wherein said location condition is based on proximity to a frame boundary.

8. The method as described in claim 6, wherein said identifying comprises:
a) forming a difference image of said current luminance image and said reference luminance image;
b) forming a binary mask from said difference image by comparing the value of each pixel in said difference image with a first threshold, wherein one binary value is associated with a pixel in said difference image being a likely occluder pixel and the other binary value is associated with a pixel in said difference image not being a likely occluder pixel;
c) dividing said binary mask into a plurality of blocks; and
d) identifying a block in said plurality of blocks as a likely occluder block based on the number of pixels in said block with a value of said one binary value.

9. The method as described in claim 1 further comprising:
a) storing a reference image associated with an un-occluded view of said collaborative writing surface; and
b) updating said reference image based on said formed image.

10. The method as described in claim 1, wherein said collaborative writing surface is a surface selected from the group consisting of flipchart, a whiteboard, a chalkboard and a piece of paper.

11. The method as described in claim 1, wherein said detecting a dis-occlusion event comprises:
a) receiving a current luminance image associated with said collaborative writing surface;
b) receiving a reference luminance image associated with said collaborative writing surface;
c) identifying a plurality of contiguous likely-occluder-blocks in an image formed using said current luminance image and said reference luminance image; and
d) declaring a dis-occlusion event when an occlusion event has been declared and no intervening dis-occlusion events have been declared and no contiguous likely-occluder-blocks in said plurality of likely-occluder-blocks meet a size condition and a location condition.

12. The method as described in claim 1 further comprising identifying an actor associated with said occlusion event or said dis-occlusion event.

13. A collaboration system comprising:
a) a collaborative writing surface;
b) an occlusion-event detector for detecting an occlusion event associated with said collaborative writing surface;
c) a dis-occlusion-event detector for detecting a dis-occlusion event associated with said detected occlusion event;
d) an image acquisition system for acquiring an image, corresponding of said collaborative writing surface; and
e) an image generator for forming an updated image based on a first image of said collaborative writing surface, acquired by said image acquisition system, corresponding to said dis-occlusion event.

14. The system as described in claim 13, wherein said collaborative writing surface is a surface selected from the group consisting of flipchart, a whiteboard, a chalkboard and a piece of paper.

15. The system as described in claim 13 further comprising an image rectifier for eliminating perspective distortion in said acquired image.

16. The system as described in claim 13 further comprising an image demosaicer for demosaicing said acquired image.

17. The system as described in claim 13 further comprising a first memory for storing an un-occluded view of said collaborative writing surface.

18. The system as described in claim 13 further comprising:
a) a change detector for determining changes between a reference image of said collaborative writing surface and said first image; and
b) wherein said image generator forms said updated image based on a result of said change detector.

19. The system as described in claim 18, wherein said change detector comprises:
a) a first edge detector for determining the edge content in a said reference image;
b) a second edge detector for determining the edge content in said captured image; and
c) an edge-content comparator for comparing said reference-image edge content to said captured-image edge content.

20. The system as described in claim 13, wherein said occlusion-event detector comprises:
a) a current-image receiver for receiving a current luminance image associated with said collaborative writing surface;
b) a reference-image receiver for receiving a reference luminance image associated with said collaborative writing surface;
c) a contiguous-likely-occluder-block identifier for identifying a plurality of contiguous likely-occluder-blocks in an image formed using said current luminance image and said reference luminance image; and
d) an occlusion-event state indicator for declaring an occlusion event when at least one contiguous likely-occluder-block in said plurality of likely-occluder-blocks meets a size condition and a location condition.

21. The system as described in claim 20, wherein said location condition is based on proximity to a frame boundary.

22. The system as described in claim 20, wherein said contiguous-likely-occluder-block identifier comprises:
a) an image differencer for forming a difference image of said current luminance image and said reference luminance image;
b) a binary-mask generator for forming a binary mask from said difference image by comparing the value of each pixel in said difference image with a first threshold, wherein one binary value is associated with a pixel in said difference image being a likely occluder pixel and the other binary value is associated with a pixel in said difference image not being a likely occluder pixel;
c) a mask partitioner for dividing said binary mask into a plurality of blocks; and
d) a block identifier for identifying a block in said plurality of blocks as a likely occluder block based on the number of pixels in said block with a value of said one binary value.

23. The system as described in claim 13 further comprising a reference-image updater for updating a reference image based on said formed image.

24. The system as described in claim 13 further comprising an actor identifier for identifying an actor associated with said occlusion event or said dis-occlusion event.
